(19) United States
(12) Patent Application Publication
(10) Pub. No.: US 2002/0194186 A1
(43) Pub. Date: Dec. 19, 2002

(54) Report design and data manipulation system and method of operation

(75) Inventor: Frederick J. Ode, Strongsville, OH (US)

Correspondence Address: HAHN LOESER & PARKS, LLP, TWIN OAKS ESTATE, 1225 W. MARKET STREET, AKRON, OH, 44313, US

(73) Assignee: Foundation Software, Inc.

(21) Appl. No.: 10/100,893

(22) Filed: Mar. 18, 2002

Related U.S. Application Data
(60) Provisional application No. 60/279,012, filed on Mar. 27, 2001.

(51) Int. Cl. G06F 7/00

(52) U.S. Cl. 707/100

(57) ABSTRACT

The present invention generally relates to an automated report writer that allows an end user to design reports by selecting desired fields from a series of predetermined data capsules that contain data relevant to the end user's industry. A data capsule designer is used to arrange the data that is stored in an enterprises' central database, into a user-friendly series of data capsules, which can be selected by the end user to build a desired report. Additionally, an end user can further customize data fields by selecting for a plurality of formatting and data options within each data capsule. As a result, the present invention provides end users with the ease of developing customized reports via a user-friendly user interface without having to access and manipulate data in the database.

### BACKGROUND OF THE INVENTION

The present invention is an automated report writer designed for integrated accounting software packages. Although there are a number of different report writers available on the market, they are extremely difficult to use for the average user. Without exception, an aptitude well above average is required to design and write a report with other report writers. Specifically, there are two major assumptions that are made by other report writers that cause great difficulty for the user:

1) Design Assumption. All other report writers assume the user is capable of analyzing their own requirements and designing a report based on this analysis. System's analysis is a highly paid position and requires both years of experience and an aptitude for skill in system analysis. To assume the typical user has this ability is a major factor in why most report writers are not used by the average user or even above average user.

2) Data Manipulation Assumption. Once a report is designed, the user must then access the database in such a manner as to gather and manipulate the data for the desired results. The problem with this is that the data in an accounting software package is typically very complex, difficult to understand and quite often voluminous in nature. Furthermore, in the relational database model there are relationships between and among columns of information that must be fully understood to arrive at the desired results. The typical accounting software package requires skilled programmers, analysis and database specialists to maintain and enhance the product. To assume the average and even above average user can begin to understand and consequently manipulate a sophisticated database is a major flaw in known report writers.

It would therefore be desirable to provide a report writer, which is easily used, by simplifying the design and systems analysis required to provide the desired results from data. Additionally, it would be desirable to provide a report writing system that allows manipulation of an associated accounting database in a desired manner, without requiring in depth knowledge of the database.

### SUMMARY OF THE INVENTION

It is therefore an object of the invention to provide a report writing system, which provides a design tool allowing the user to effectively design a report having desired information for systems analysis. The design tool utilizes one or more predefined data retrieval options created for the types of projects to be analyzed. The automated report writer of the invention addresses the problems noted in prior report writing systems, and provides a simple and yet effective report generator that can be used by the typical user.

The report writing system comprises a means for acquiring data from a predetermined database, and means for organizing data obtained by the data acquiring means within a plurality of data fields located within a plurality of selected data capsules. There may also be provided means for accessing, organizing, and customizing the plurality of data capsules into a desired arrangement, and means for generating a desired report based on the arrangement, selection, and customization of the data capsules. In an embodiment, the data capsule designer comprises a plurality of data capsules having a plurality of data fields, whereby the data fields of the at least one data capsule are capable of being customized to receive a set of corresponding data from at least one database. A user interface is provided for creating a report, and comprises tools for allowing a user to organize the plurality of data capsules into a desired format. The arrangement of the data capsules may comprise a plurality of options within each data capsule that allow each data capsules to be arranged and customized by the user in a desired manner to achieve the desired report design.

The invention is also directed to a method for generating a report comprising the steps of defining a plurality of data capsules and data fields within each data capsule, linking a selected data field within a selected data capsule to a predetermined database, and generating a plurality of values based on predetermined formulas and data contained within the data fields of the selected data capsule. A desired combination of data capsules is selected in which to build a report, and the data is formatted within a data capsule according to a plurality of predetermined criteria selected by the user. A report is generated corresponding to the user selected data capsules and options selected by the user within each selected data capsule. The invention is also directed to a method for designing a data capsule for a report writing system comprising selecting a plurality of desired data fields that are to be made available to a user within an at least one data capsule, and importing data to each corresponding data field within the desired data capsule. The plurality of data fields are organized within each at least one data capsule according to a predetermined criteria. Organizing the data capsules into a desired arrangement, and selecting an option within each data capsule to further customize the report design a report.

Other objects and advantages of the invention will become apparent upon a reading of a description of the invention in conjunction with the drawings.

### BRIEF DESCRIPTION OF THE DRAWINGS

FIG. 1 represents a simple overview of the entire Report Writer process

FIG. 2 is a diagram of options in the Data Capsule Designer

FIG. 3 details the options for the ID/Code Capsule

FIG. 4 details the options for the ID/Code Description Capsule

FIG. 5 details the options for the Numeric Capsule

FIG. 6 details the options for the Pre-defined Formula Capsule

FIG. 7 details the options for the Miscellaneous Capsule

FIG. 8 details the options for the Calculation Capsule

FIG. 9 is an example of the Report Categories for Construction Accounting

FIG. 10 is an example of Data Capsules for Job Cost Reporting

FIG. 11 is an example of Drop Downs for a Numeric Data Capsule

FIG. 12 is an example of a completed Data Capsule screen for a Job Cost Report

### DETAILED DESCRIPTION OF THE INVENTION

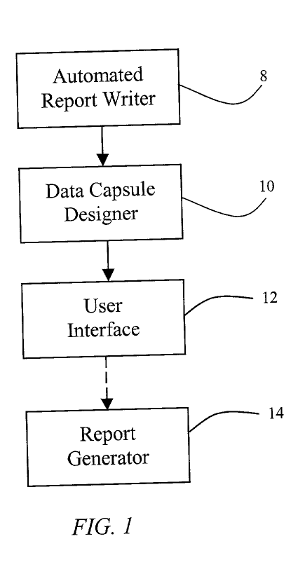

In general, the report writing system generally designated 8 comprises two major components: 1) the data capsule designer 10 and 2) the user interface 12. The automated report writing system and methods are generally based on the premise that, relative to an existing accounting software system, a finite number of data retrieval options exist. The options made available to the user are predetermined and may be defined by a suitable consultant, such as the accounting software vendor. With reference to FIG. 1, based on the characteristics of a specific vertical market, such as the construction industry, the report writer 8 will provide at least one data capsule, which is predefined and made available to the user. The creation of data capsules in the report writer 8 is accomplished through the use of a data capsule designer 10. Use of the data capsule designer 10 requires extensive knowledge of the database as well as the ability to retrieve and manipulate the data contained in the database. Furthermore, the data capsule designer 10 uses industry knowledge specific to the accounting software in order to insure that all relevant data capsules are defined for the end user. Once the pre-defined data capsules are provided in this manner according to the invention, the two most difficult tasks in report writing are eliminated for the end user.

The user interface 12 combines report design and data manipulation into a one step process for the end user. The key to this one step process is the use of pre-defined data capsules developed by using the data capsule designer 10. These data capsules provide the user with an assist or prompting mechanism in designing their report, while at the same time allowing the user to bypass the extremely difficult task of working directly with the database. The unique use of the data capsule eliminates two very complex steps (report design and data manipulation) and combines them into a single, easy to use process.

The user is presented via the user interface a series of data capsules from which to select. By simply “clicking and dragging” on a data capsule one at a time, the user will build their report. The data capsules are easy for the user to understand since they deal directly with the type of information their industry requires. The user is completely shielded from working directly with the database. Furthermore, by being presented with options, they are able to readily work their way through the design phase of the report. In addition, the user is able to preview the end report at any time and make adjustments as required.

Other report writers do not provide a pre-defined series or list of data retrieval options. Hence, the user is required to determine on their own what type of information they require. As stated earlier, this is the job of a highly trained system's analyst. With the automated report writer 8, the user is presented with their options and works their way through the design process based on a series of pre-defined data capsules. Once the report is designed, there is then no need to work with the database. This was accomplished simultaneously with the designing of the report.

The data capsule technology takes a complex and difficult process and reduces it to a single step process that the user immediately understands and can work with. Issues such as Year-to-Date, Current-Period and any number of subtotal and accumulator information is all addressed in a single Data Capsule. All mathematical and conditional scenarios are readily addressed within the Data Capsule. Everything that makes a typical report writer difficult to work with is eliminated through the use of data capsules.

The report generator 14 is a program that interprets the information created through the user interface 12 and generates the appropriate report. Any suitable report generator 14 may be used in this regard, and can comprise one or more programs. Known report generators 14 may be integrated for use with the report writer 8 according to the invention, and specific details of such programs should not limit or be construed to be a part of the automated report writer 8.

The data capsule designer 10 is the component used to pre-define data retrieval options for a type of application. Its' purpose is to allow the design of the user interface 12 specific to the type of accounting software application. Once the data capsules are designed using the designer 10, the end user of the automated report writer 8 will never see or even be aware that the data capsule designer 10 exists. The data capsule designer 10 has a set of procedures and mechanisms that structures the user interface 12 for the end user. The data capsule designer 10 is the component used in building the finished product for the end user, specific to the accounting software package that they are using. Without the data capsule designer 10, the user interface 12 could not exist.

The user interface 12 is the component that interfaces with the end user. As discussed above, the user interface 12 combines the two most difficult aspects of writing a report (report design and data manipulation) into a simple one step process. With the user interface 12, a report is written based on the user selecting data capsules from a list and choosing from a set of options within the data capsule. Once this is accomplished, the report has been designed. Data manipulation is a direct result of the design process and requires no additional steps. This aspect of the user interface. 12 is unique and represents the core of the product. The subsequent step of sizing columns, formatting fields, moving columns and the like is an easy process and typical of most report writers.

The report generator 14 is provided for integration into the system, for actual production of a report, but no special tools, software code or utilities are generally required or provided in regards to this component. However, detailed reports of the tables and data generated from the data capsule designer 10 and the user interface 12 may be provided, as well as documentation on interpreting this information. In addition, suggested design techniques and templates may also be provided. At the same time, these materials are not required for effective use of the inventive system. The data capsule designer 10 and the user interface 12 can be used with various report generators 14. The design of the report generator 14 is based on the tables and information generated through the data capsule designer 10 and subsequently the user interface 12. The report generator 14 may be in any language (i.e. Visual Basic, COBOL, Visual FoxPro) and access any database (i.e. Microsoft SQL Server, Sybase SQL Anywhere or a flat Indexed Sequential file system). It is the data capsule designer 10 and the subsequent data generated from the user interface 12 that provides the required information for the software vendor to design the report generator 14.

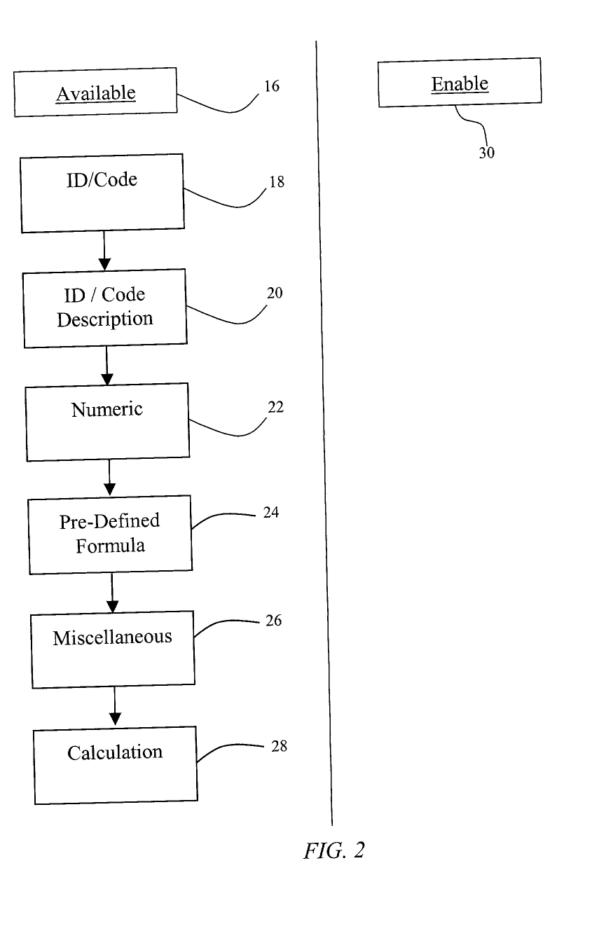

FIG. 2 illustrates the main components of the data capsule designer 10 that is available to the software developer. The data capsule designer 10 is the means in which the software developer will customize the user interface 12 to match the requirements of their accounting software. The data capsule designer 10 is not available to the end user. It is the vehicle in which the software developer can customize the user interface 12 to match the requirements of the end user for their vertical market (i.e. Construction Accounting software).

A plurality of data capsules may be provided, and various non-limiting examples are described herein. As the capsules may be designed to accommodate a wide variety of accounting software applications, the particular nature of the data capsules can vary significantly. As shown, the data capsules may comprise an Available data capsule 16, the ID/Code 18, ID/Code Description 20, Numeric 22, Pre-Defined Formula 24, Miscellaneous 26 and Calculation 28 capsules. Any capsule may be used more than one time. For example, in Construction Accounting software, the Numeric capsule 22 could be used to represent Costs, Hours and Quantities.

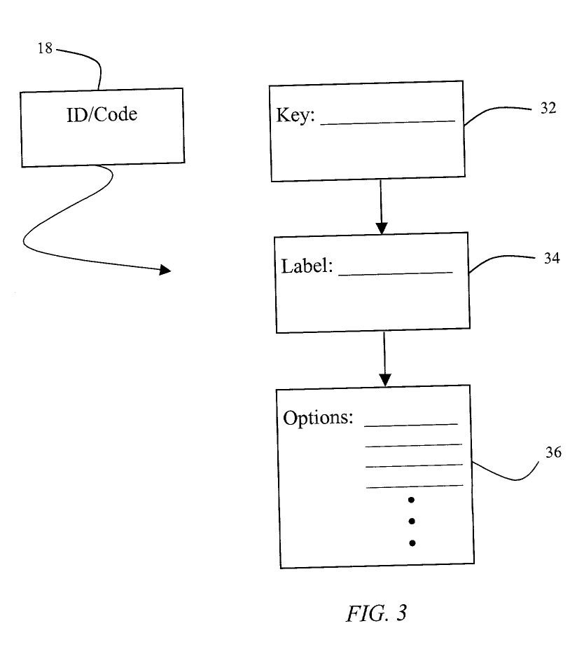

In customizing the user interface 12, the software developer will drag (or double click) on one of the six Available 16 data capsules and move it into the Enabled 30 column. Once a capsule is in the Enabled Capsules 30 column, the software developer will select from various options in order to customize the Data Capsule to meet the requirements of their accounting software. This is fully described in FIG. 3 through FIG. 8.

FIG. 3 shows the options for customization of the ID/Code Capsule 18. The ID/Code 18 is intended to represent the main driving element for extracting records when building a report. For example, in Construction Software, you may want to extract data for all of the Cost Codes within any given Job. This would result in at least two options being made available to the end user—Job Number and Cost Code Number.

The Key 32 is numeric and automatically generated based on the capsule's position in the Enabled Capsule 30 column. For example, if the ID/Code Capsule 18 is dragged into the third position from the top, it will have a Key 32 value of three. Subsequently, if the data capsule is moved into the first position, it will take on a new Key 32 value of one. The Key 32 is used for positioning of the data capsules for end user use and for reference purposes when generating a report.

The Label 34 is descriptive field that the end user will see to identify the Available Capsules 108 when building a report. For example, this may be Code Number, ID Code or ID Number.

The Options 36 may be an unlimited hardcode list of options or may refer to a table of unlimited user-defined values. For example, in Construction Accounting Software the software developer may enter Job Number, Phase Number or Cost Code in the first three positions of Options 36. Typically the Options 36 is a hard coded list of values based on the industry specific nature of the accounting software. However, if a table of user defined values is intended to populate Options 36, this may be done by preceding the Table Name with “**” and ending it with “**”. For example, if the table name is “TASKVALUES”, the software developer would enter “**TASKVALUES**” into the first Options 36 slot. Then when the end user is using the user interface 12 to design a report, they will see all of the rows from the TASKVALUES table in the drop down box

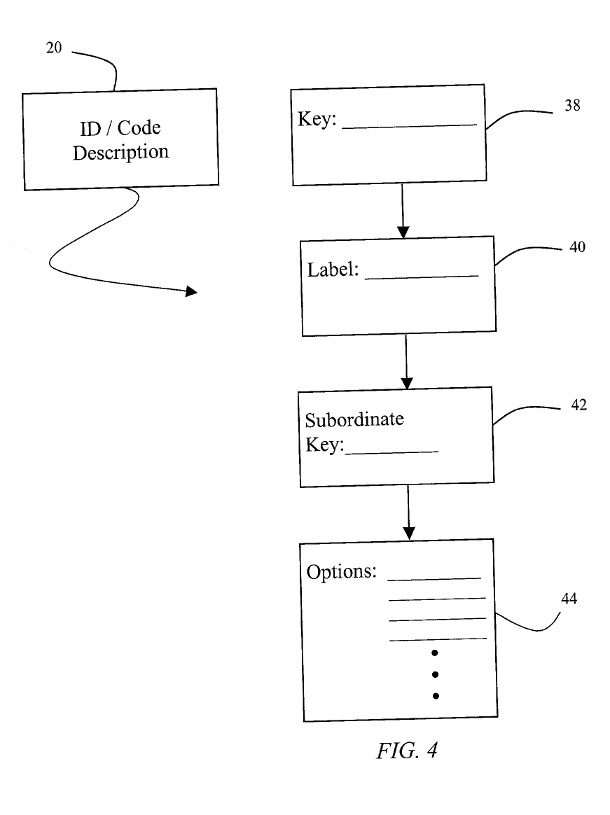

FIG. 4 illustrates the ID/Code Description 20 which is directly tied to an enabled ID/Code 18. Basically, this capsule is intended to allow the end user to add descriptions and names to their report. For example, if a Job Number is selected via the ID/Code 18 capsule, then the natural extension of this is to report the Job Name with the Job Number.

The Key 38 is numeric and automatically generated based on the capsule's position in the Enabled Capsule 30 column. For example, if the ID/Code Description 20 capsule is dragged into the third position from the top, it will have a Key 38 value of three. Subsequently, if the data capsule is moved into the first position, it will take on a new Key 38 value of one. The Key 38 is used for positioning of the data capsules for end user use and for reference purposes when generating a report.

The Label 40 is a descriptive field that the end user will see to identify the Available Capsules 108 when building a report. For example, this may be Description, Name or Description/Name.

The Subordinate Key 42 refers to the Key 32 of the associated ID/Code 18 capsule. For example, assume the software developer has created an ID/Code 18 capsule with a Key 32 value of 1 and another with a Key 32 value of 3. In the Subordinate Key 42 either a 1 or 3 must be entered to refer to the correct ID/Code 18 capsule.

The Options 44 may be an unlimited hardcode list of options or may refer to a table of unlimited user-defined values. For example, in Construction Accounting software the software developer may enter Job Name, Phase Description or Cost Code Description in the first three positions of Options 44. Typically the Options 44 is a hard coded list of values based on the industry specific nature of the accounting software. However, if a table of user defined values is intended to populate Options 44, this may be done by preceding the Table Name with “**” and ending it with “**”. For example, if the table name is “TASKDESC”, the software developer would enter “**TASKDESC**” into the first Options 44 slot. Then when the end user is using the user interface 12 to design a report, they will see all of the rows from the TASKDESC table in the drop down box.

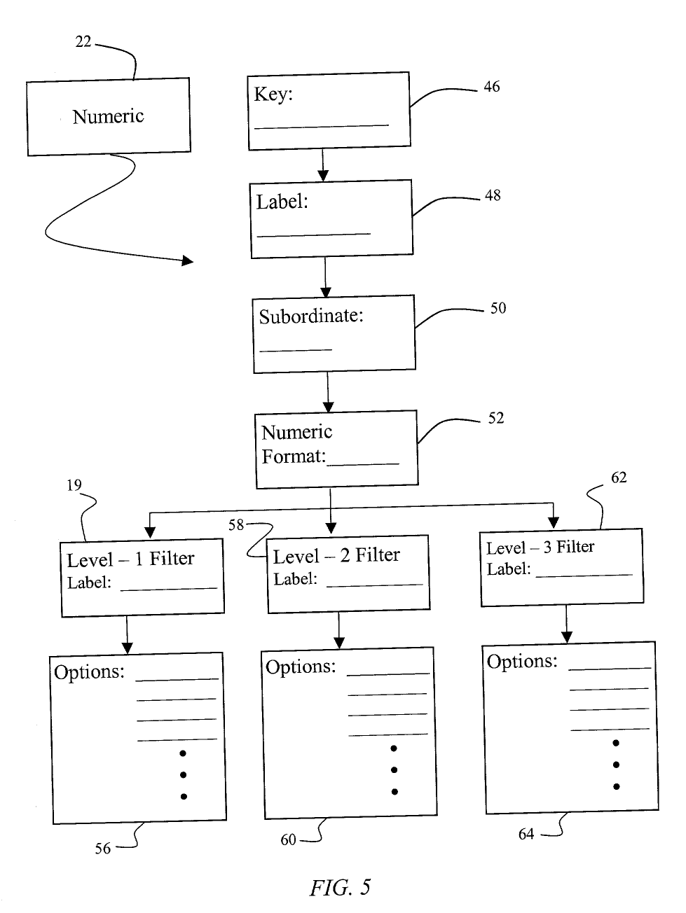

FIG. 5 shows the Numeric 22 capsule which is directly tied to an enabled ID/Code 18. Basically, this capsule is intended to allow the end user to gather data that is directly tied to the ID/Code 18. For example, in Construction Accounting software if a Job Number is selected via the ID/Code 18 capsule, then the natural extension of this is to report data against the Job Number.

The Key 46 is numeric and automatically generated based on the capsule's position in the Enabled Capsule 30 column. For example, if the Numeric 22 capsule is dragged into the third position from the top, it will have a Key 46 value of three. Subsequently, if the data capsule is moved into the first position, it will take on a new Key 46 value of one. The Key 46 is used for positioning of the data capsules for end user use and for references purposes when generating a report. In addition, it is used for computational reference in Pre-Defined Formulas 24, Miscellaneous 26 and Calculations 28.

The Label 48 is a descriptive field that the end user will see to identify the Available Capsules 108 when building a report. For example, in Construction Accounting software this may be Cost, Hours or Quantities.

The Subordinate Key 50 refers to the Key 32 of the associated ID/Code 18 capsule. For example, assume the software developer has created an ID/Code 18 capsule with a Key 32 value of 1 and another with a Key 32 value of 3. In the Subordinate Key 50 either a 1 or 3 must be entered to refer to the correct ID/Code 18 capsule. The data gathered will be directly tied to the referenced ID/Code 18 capsule. For example, in Construction Accounting software a user may build a report with an ID/Code 18 capsule with a value for a Job Number. If the Subordinate Key 50 has a value tied to the Job Number, then data will be gathered against the Job Number currently in play as the report is generated.

Numeric Format 52 is utilized to specify the default numeric format for the report. For example, for a dollars field the software developer may enter 99,999,999.99 indicating 8 places to the left of the decimal with full commas and two places to the right of the decimal. This default may be overridden at the time of report design by the end user.

Level-1 Filter 54 & Options 56, Level-2 Filter 58 & Options 60 and Level-3 Filter 62 & Options 64 are designed to allow the software developer to specify up to three levels of filters for extracting historical or transaction based data against a specified table. For example, in Construction Accounting software two levels may be specified as follows:

| Type or Date | Cost Class |
|---|---|
| Current Period | Labor |
| Previous Period | Material |
| Year-To-Date | Subcontract |
| Job-To-Date | Equipment |
| Original Estimate | Labor Burden |
| Revised Estimate | Miscellaneous |

The “Type or Date” represents the Level-1 Filter Label 54 and the Current Period, Previous Period, etc. represents a hard coded Options 56 list. The “Cost Class” represents the Level-2 Filter Label 58 and Labor, Material, etc. represents a table of user-defined values. If a table of user defined values is intended to populate Options 60, this may be done by preceding the Table Name with “**” and ending it with “**”. For example, if the table name is “COSTCLASS”, the software developer would enter “**COSTCLASS**” into the Options 56 or 60 slot. Then when the end user is using the user interface 12 to design a report, they will see all of the rows from the COSTCLASS table in the drop down box.

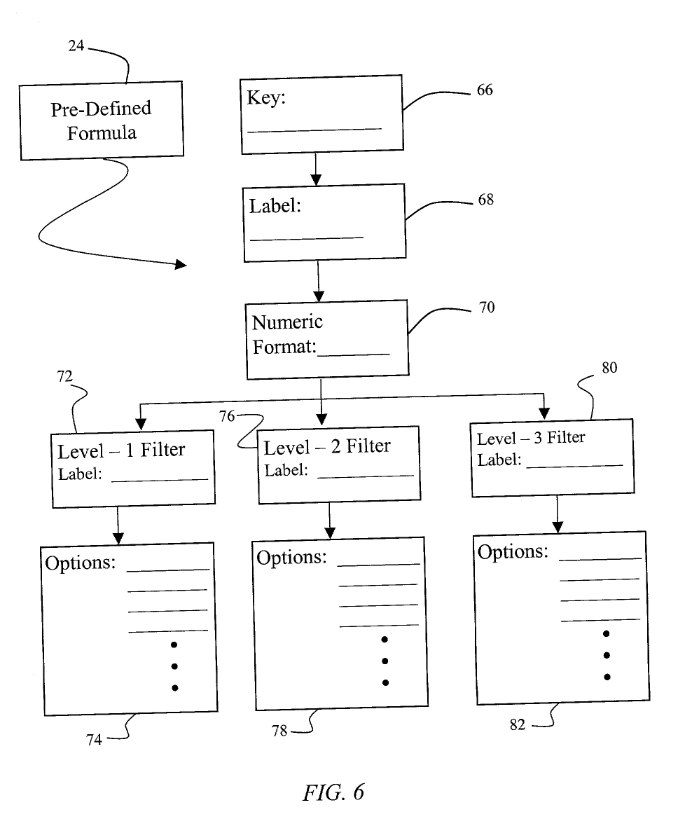

FIG. 6 illustrates the Pre-Defined Formula 24 capsule that is designed to provide the software developer with the opportunity to define formulas specific to their industry. For example, in Construction Accounting software the concept of production is a common formula. Production is typically calculated as quantity divided by hours. A specific example would be cubic yards of concrete poured per man-hour.

The Key 66 is numeric and automatically generated based on the capsule's position in the Enabled Capsule 30 column. For example, if the Pre-Defined 24 capsule is dragged into the third position from the top, it will have a Key 66 value of three. Subsequently, if the data capsule is moved into the first position, it will take on a new Key 66 value of one. The Key 66 is used for positioning of the data capsules for end user use and for references purposes when generating a report. In addition, it is used for computational references in Miscellaneous 26, Calculations 28 and other Pre-Defined Formula 24 capsules.

The Label 68 is descriptive field that the end user will see to identify the Available Capsules 108 when building a report. For example, in Construction Accounting software this may be Production or Percent Complete.

Numeric Format 70 is required to specify the default numeric format for the report. For example, for a dollars field the software developer may enter 99,999,999.99 indicating 8 places to the left of the decimal with full commas and two places to the right of the decimal. This default may be overridden at the time of report design by the end user.

Level-1 Filter 72 & Options 74, Level-2 Filter 76 & Options 78 and Level-3 Filter 80 & Options 82 are designed to allow the software developer to specify up to three levels of filters for extracting historical or transaction based data against a specified table. For example, in Construction Accounting software for a production calculation, you may specify the following Level-1 Filter 72 & Options 74.

Type or Date

Current Period

Previous Period

Year-To-Date

Job-To-Date

Original Estimate

Revised Estimate

The “Type or Date” represents the Level-1 Filter Label 72 and the Current Period, Previous Period, etc. represents a hard coded Options 74 list. If a table of user defined values is intended to populate Options 74, this may be done by preceding the Table Name with “**” and ending it with “**”. For example, if the table name is “PRODFORMS”, the software developer would enter “**PRODFORMS**” into the Options 74. Then when the end user is using the user interface 12 to design a report, they will see all of the rows from the PRODFORMS table in the drop down box.

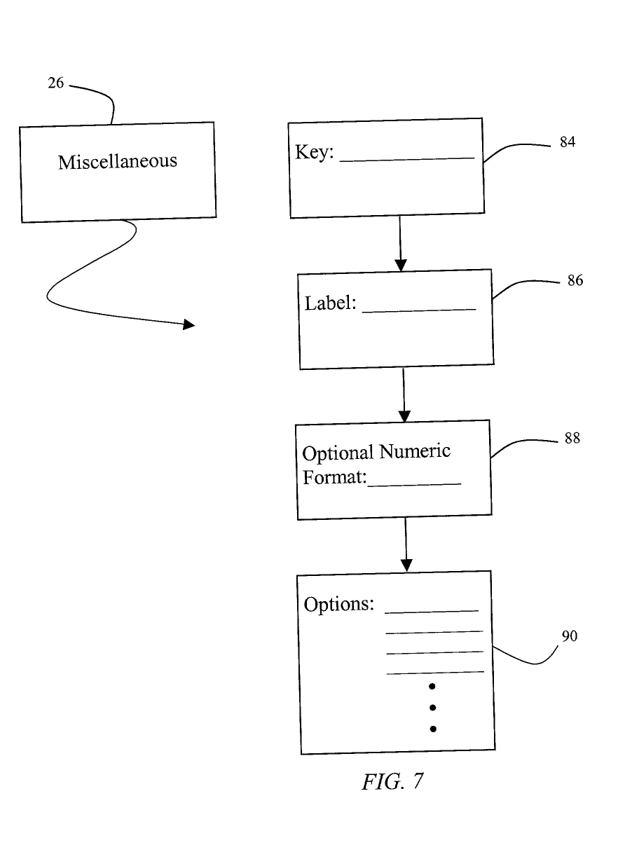

FIG. 7 shows the Miscellaneous 26 capsule, which is provided to allow for situations unique to the accounting software package. This is typically used where a formula or calculation driven solution is either unworkable or cumbersome. For example, in tax accounting there are some very complex and seemingly illogical rules. A report based on these complex sets of rules could be addressed through the use of the Miscellaneous 26 data capsule.

The Key 84 is numeric and automatically generated based on the capsule's position in the Enabled Capsule 30 column. For example, if the Miscellaneous Capsule 26 is dragged into the third position from the top, it will have a Key 84 value of three. Subsequently, if the data capsule is moved into the first position, it will take on a new Key 84 value of one. The Key 84 is used for positioning of the data capsules for end user use and for references purposes when generating a report.

The Label 86 is descriptive field that the end user will see to identify the Available Capsules 108 when building a report. Typically this would be Miscellaneous, Other or Unique.

Optional Numeric Format 88 is an optional field used to specify the default numeric formats when appropriate to the capsule. However, since the capsule may be used to print words, issue warnings, etc., a numeric format may not be relevant.

The Options 90 may be an unlimited hardcode list of options or may refer to a table of unlimited user-defined values. For example, in Construction Accounting Software the software developer may enter Over/Under Billing, Bonding Required or Draw Due in the first three positions of Options 90. Typically the Options 90 is a hard coded list of values based on the industry specific nature of the accounting software. However, if a table of user defined values is intended to populate Options 90, this may be done by preceding the Table Name with “**” and ending it with “**”. For example, if the table name is “EXCEPTIONS”, the software developer would enter “**EXCEPTIONS**” into the first Options 90 slot. Then when the end user is using the user interface 12 to design a report, they will see all of the rows from the EXCEPTIONS table in the drop down box.

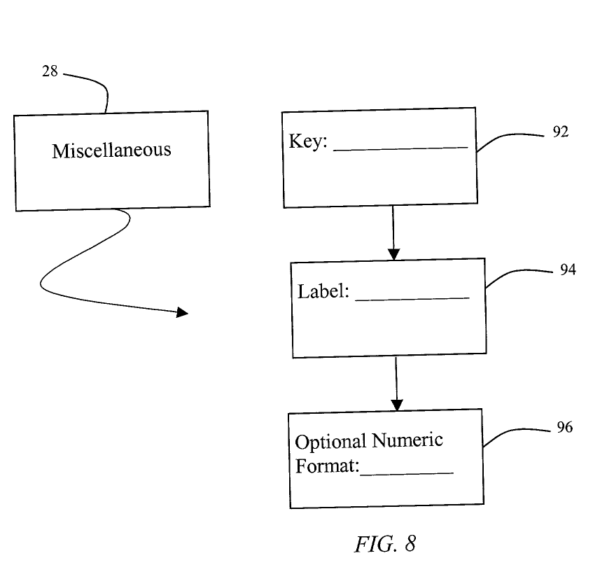

FIG. 8 illustrates the Calculation 28 capsule that is provided to allow the user to perform calculations among columns of information. In addition to calculations, sophisticated IF THEN logic is provided for the end user. Simple calculations will allow the end user to perform basic math among two or more columns of information. Constants may be used in the calculations. Calculations or fixed values may be applied based on conditional statements. More sophisticated computations can also be performed using scientific and engineering notations.

The Key 92 is numeric and automatically generated based on the capsule's position in the Enabled Capsule 30 column. For example, if the Calculation capsule 28 is dragged into the third position from the top, it will have a Key 92 value of three. Subsequently, if the data capsule is moved into the first position, it will take on a new Key 92 value of one. The Key 92 is used for positioning of the data capsules for end user use and for references purposes when generating a report. In addition, it is used for computational reference in Pre-Defined Formulas 24 Miscellaneous 26 and other Calculations 28.

The Label 94 is descriptive field that the end user will see to identify the Available Capsules 108 when building a report. Typically this Label 94 will be something simple such as Computations or Calculations or Column Calculations.

Numeric Format 96 is required to specify the default numeric format for the report. For example, the software developer may enter 99,999,999.999 indicating eight places to the left of the decimal with full commas and three places to the right of the decimal. This default may be overridden at the time of report design by the end user.

With the user interface 12, a report is written based on the user selecting Data Capsules from a list and choosing from a set of options within the Data Capsule. Once this is accomplished, the report has been designed. The subsequent step of sizing columns, formatting fields, moving columns and the like is an easy process and typical of most report writers.

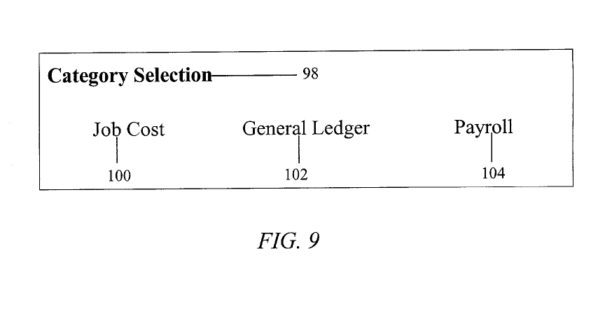

As an illustration, we will examine how a typical user may define a new Job Cost report with the user interface 12. The first Window presented to the user will provide a set of report categories such as Job Cost, General Ledger and Payroll. The user will select the category of report. FIG. 9 illustrates the Category Selection 98 available with Job Cost 100 as the selected category.

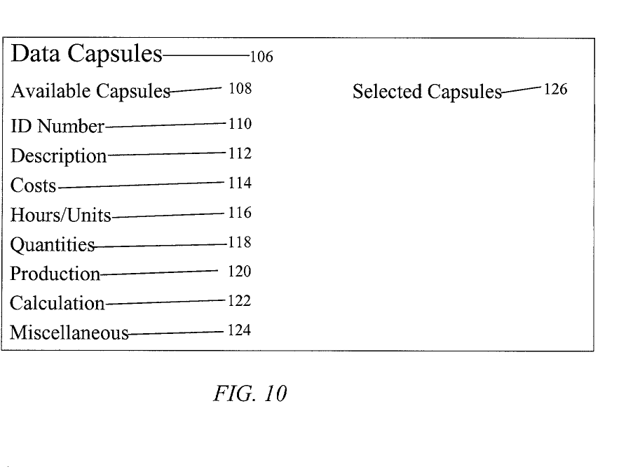

FIG. 10 is an example of the next Window displayed when a user builds a new report. Data Capsules 106 represents the uniqueness of the user interface 12. The entire Job Cost Report will be designed from this Window. Initially, a series of Data Capsules will appear under Available Capsules 108. These Data Capsules represent all of the reporting options available to the user for designing a Job Cost Report. The user will select Data Capsules from the first column and drag (or double click) them, one at a time, into the second column. Once they are in the second column, the user will click on certain options within the Data Capsule to allow for a more specific definition of the information to be reported.

It is noted that all of the “Available Capsules” 110-124 are pre-defined sets of data determined and programmed by the software vendor through the Data Capsule Designer 10. The Data Capsules 110-124 often access several database tables with a variety of filter, subtotal and accumulated amounts. However, the user is not exposed to the raw tables and therefore is able to readily understand the Data Capsules 110-124 presented to them as they represent concepts that the user works with on a daily basis.

In order to carry this illustration further, let's examine each Data Capsule 110-124 in more detail relative to the Job Cost 100 Category. We will also assume the user selects various Data Capsules 110-124 for their report design.

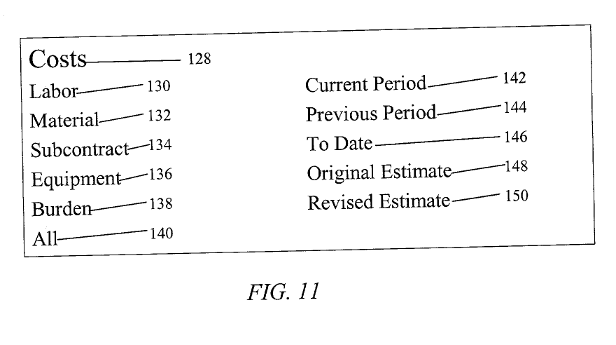

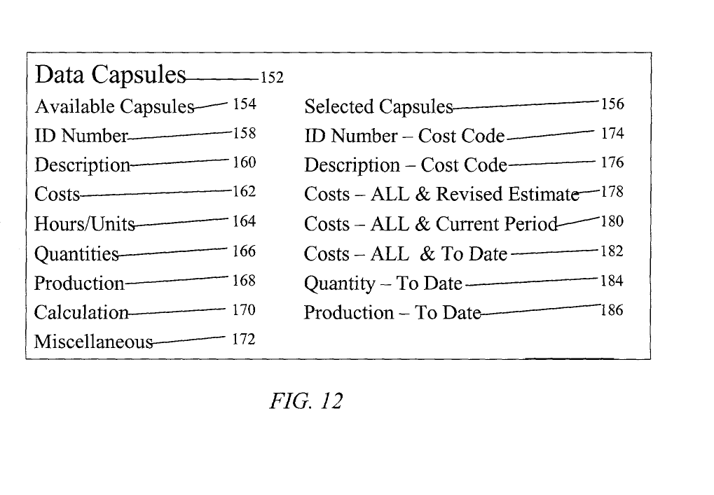

Note: FIG. 12 illustrates the Data Capsules 152 Window after all of the Data Capsules 158-172 have been selected and modified by the user. FIG. 11 is an example of two drop down boxes for the Costs 162 data capsule

ID Number 158—This can be a Job Number, Phase Number or Cost Code Number. A drop-down box will provide the user with these three options. Let's assume the user selects Cost Code Number for column one of the report. The result is that the first column of the finished report will be Cost Code 174.

Description 160—This can be a Job, Phase or Cost Code Description. Since the ID Number is Cost Code 174, the user will select Cost Code Description 176 for column two of the report. This results in the 2nd column of the report being a description of the Cost Code ID 174 in column one of the report.

Costs 162—These are the costs associated with the ID Number (Cost Code). This Data Capsule is much more complex than the first two since costs may include Labor 130, Material 132, Subcontract 134, Equipment 136, Burden 138 and may be for the Current Period 142, Previous Period 144, To Date 146, Original Estimated 148 or Revised Estimated 150. However, these options are easily addressed through two drop-down boxes attached to the Cost Data Capsule 162. The two drop-down boxes (FIG. 11 130-140/142-150) were pre-defined according to an example of the invention and may contain more or less options than those illustrated.

Let's assume that the user wants the Revised Estimated 150 cost for ALL 140 costs associated with the Cost Code. The user would then select ALL 140 and Revised Estimate 150 after dragging the Cost Data Capsule 162 into the Selected Capsules 156 column.

In addition to the Revised Estimated Cost 178, the user wants the Current Period 142 and To Date 146 Costs. This would be accomplished by dragging the Cost Data Capsule 162 into the Selected Capsules 156 column two more times and clicking on ALL 140 & Current Period 142 and then ALL 140 & To Date 146 respectively.

Hours/Units 164—This represents hours or units as pre-defined as described. Similar to the Cost Data Capsule 162, Hours/Units 164 may be selected based on the same two drop-down boxes 130-140/142-150 as the Cost Data Capsule 162. Let's assume the user wants labor hours worked to date. They would then select the Hour/Units 164 Data Capsule for Labor 130 and To Date 146.

Quantities 166—This represents the quantity of work completed against the Cost Code. The type of quantity (i.e. cubic yards, square feet, linear feet, etc) is inherent in the application and is attached to the Cost Code definition through the application. The data capsules allow the designer to account for this in their building of the Data Capsules and the Report Generator. Quantities 166 have one drop down box attached that specify Current Period 142, Previous Period 144, To Date 146, Original Estimate 148 and Revised Estimate 150. Let's assume the user drags the Quantity 166 Data Capsule into the Selected Capsules 156 column and clicks on To Date 146.

Production 168—Production is inherent in the application and is attached to the Cost Code definition. For purposes of this illustration, we will assume that if a Cost Code has production attached to it that it will be computed based on Quantity divided by hours (i.e. Cubic Yards per Man Hour). The Production 168 Data Capsule has one drop-down box attached that specifies Current Period 142, Previous Period 144, To Date 146, Original Estimate 148 and Revised Estimate 150. Let's assume the user drags the Production 168 Data Capsule into the Selected Capsules 156 column and clicks on To Date 146.

Calculation 170—This Data Capsule is provided to allow the user to perform simple and/or complex calculations on the columns. In addition, more sophisticated “If-Then” logic is provided to accommodate more complex logic. For example, if a column is to determine a percentage and you want to limit the percentage to no more than 100%, you could use the “If-Then” logic to accomplish this. In our example, let's assume the user does not use this Data Capsule.

Miscellaneous 172—This Data Capsule is made available so that the software vendor may accommodate unusual or unique situations specific to their software application. For example, in Job Cost 100 this specific application has a unique method for determining Overhead Allocation and Over/Under Billing. The Miscellaneous 172 Data Capsule will accommodate this unusual method and completely shield the user from determining how to gather and manipulate the data. Let's assume the user does not use this Data Capsule.

Basically, short of any cosmetic changes, the design and writing of this Job Cost Report is complete. With the use of Data Capsules, the user was guided through the process with a pre-defined, finite set of Data Capsules. Once the report has been designed as above, data retrieval and data manipulation is automatic. In short, this most difficult step has been eliminated from the process.

Following the Data Capsules Window a window will be displayed showing the report in a form that will closely match the final output. Through this Window, the user may change column headings determine decimal places, rounding, field justification and the like. These cosmetic changes are straightforward and easy to use. The final Window allows the user to name the report and the user interface 12 will then save the report permanently in the system. The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

1. A system for generating reports comprising:
a means for acquiring data from a predetermined database;
a means for organizing data obtained by the data acquiring means within a plurality of data fields located within a plurality of selected data capsules;
a means for accessing, organizing, and customizing the plurality of data capsules into a desired arrangement; and
a means for generating a desired report based on the arrangement, selection, and customization of the data capsules.

2. A system for generating reports comprising:
a data capsule designer comprising:
a plurality of data capsules having a plurality of data fields, whereby the data fields of at least one of the plurality of data capsules are capable of being customized to receive a set of corresponding data from an at least one database; and
a user interface for creating a report comprising:
a means for allowing a user to organize the plurality of data capsules into a desired format; and
at least one data capsule having a plurality of options within the at least one data capsule that allow the at least one data capsule to be arranged and customized by the user in a desired manner to generate a desired report design.

3. A system for generating reports as recited in claim 2, wherein the plurality of data capsules include at least one ID/Code data capsule comprising:
a key data field;
a label data field; and
an options data field.

4. A system for generating reports as recited in claim 2, wherein the plurality of data capsules include at least one ID/Code Description data capsule comprising:
a key field;
a label field;
a subordinate key field; and
an options field.

5. A system for generating reports as recited in claim 2, wherein the plurality of data capsules include at least one numeric data capsule comprising:
a key field;
a label field;
a subordinate field;
a numeric format field;
a plurality of customizable data filters; and
a plurality of customizable options fields.

6. A system for generating reports as recited in claim 2, wherein the plurality of data capsules include at least one pre-defined formula data capsule comprising:
a key field;
a label field;
a numeric format field;
a plurality of customizable data filters; and
a plurality of customizable options fields.

7. A system for generating reports as recited in claim 2, wherein the plurality of data capsules include at least one miscellaneous data capsule comprising:
a key field;
a label field; and
a customizable options field.

8. A system for generating reports as recited in claim 7, wherein the at least one miscellaneous data capsule further comprises:
a numeric format field.

9. A system for generating reports as recited in claim 2, wherein the plurality of data capsules include at least one calculation capsule comprising:
a key field; and
a label field.

10. A system for generating reports as recited in claim 9, wherein the at least one calculation capsule further comprises:
a numeric format field.

11. A method for generating a report comprising the steps of:
defining a plurality of data capsules and data fields within each data capsule according data in at least one database;
linking a selected data field within a selected data capsule to the at least one database;
generating a plurality of values based on predetermined formulas and data contained within the data fields of the selected data capsule;
selecting a desired combination of data capsules in which to build a report;
formatting the data within a data capsule according to a plurality of predetermined criteria selected by the user; and
generating a report corresponding to the user selected data capsules and options selected by the user within each selected data capsule.

12. A method for designing a report comprising:
selecting a plurality of desired data fields that are to be made available to a user within at least one data capsule;
importing data to each corresponding data field within the desired data capsule;
organizing the plurality of data fields within each at least one data capsule according to a predetermined criteria; and
designing a report by organizing a the data capsules into a desired arrangement; and

13. A method for designing a report as recited in claim 12, further comprising the step of selecting an option within at least one data capsule to further customize the report.

14. A method for designing a report as recited in claim 12, wherein the data fields are selected for application to the construction industry.

15. A method for designing a report as recited in claim 12, wherein the selected option allows the user to perform mathematical analysis on one or more data fields within the selected data capsule.

16. A method for designing a report as recited in claim 12, wherein the at least one data capsule is provided with at least one field selected from the group consisting of:
a key field comprising an automatically generated numeric value based on the data capsule's position with respect to other data capsule's positions, a label field comprising a descriptive field that will enable a user to identify other available data capsules when designing a report, one or more options fields comprising a list of options or a table of user-defined values, a subordinate key field, a numeric format field, and one or more data filters that extract or filter data from at least one user specified table according to specified criteria or combinations thereof.

17. A method for designing a report using an accounting software system, comprising the steps of:
providing at least one database having data for use by an accounting software system;
providing at least one data capsule representing at least one pre-defined data retrieval option with respect to the at least one database, wherein the at least one data capsule is selectively used to retrieve the pre-defined data for generation of a report using the pre-defined data.

18. A method for designing a report as recited in claim 17, wherein the at least one data capsule retrieves data from a plurality of database tables and comprises various filter, subtotal and accumulated amounts relating to the retrieved data.

19. A method for designing a report as recited in claim 17, further comprising the step of providing a user interface for allowing a user to organize the at least one data capsule into a desired format, wherein the at least one data capsule has a plurality of options within the at least one data capsule that allow the at least one data capsule to be arranged and customized by the user in a desired manner to generate a desired report design.

20. A system for producing a report comprising:
a computer program for organizing data fields into at least one data capsule for the retrieval of data relating to the data fields from at least one database; and
a computer program for providing a interface for manipulation of the at least one data capsule, wherein data relating to the data fields is automatically retrieved to produce a desired report without direct manipulation of the data in the at least one database by a user.

21. A computer program product comprising:
a computer usable medium having computer readable program code means embodied in said medium for organizing and creating a report using data retrieved from at least one database, and
the computer usable medium having computer readable program code means embodied in said medium for automatically retrieving data based upon an arrangement of data fields in at least one data capsule.
